(19) United States
(12) Patent Application Publication
(10) Pub. No.: US 2019/0056090 A1
(43) Pub. Date: Feb. 21, 2019

(54) Burn and Shock Resistant Cage for Himalayan Salt Lamp with Heated Massage Stones

(71) Applicant: Attai Shahzad, Verona, PA (US)

(72) Inventor: Attai Shahzad, Verona, PA (US)

(21) Appl. No.: 15/678,687

(22) Filed: Aug. 16, 2017

(51) Int. Cl. F21V 15/01; F21V 19/00; F21V 17/12

(52) U.S. Cl. CPC F21V 15/01; F21V 19/0065; A61H 2201/0221; A61H 2201/0207; F21V 17/12

(57) ABSTRACT

A salt stone massage therapy lamp is disclosed. The salt stone massage therapy lamp includes a base and a translucent bowl mounted atop the base. An incandescent light bulb as provided as a light source and a heating element for heating a plurality of massage stones. The salt stone massage therapy lamp further includes a mechanism for protecting the incandescent light bulb and preventing the massage stones from damaging bulb and/or burning consumer.

### BACKGROUND OF THE INVENTION

Salt lamps with massage stones may serve multiple purposes. First, they may be employed to provide soft ambient lighting for a massage therapy session. The soft light and color may begin to soothe and relax a massage patient even before the actual massage begins.

Salt lamps with massage stones have been on the market a number of years from many manufacturers, under many names. However none include our new and unique shock and burn resistant safety cage.

A salt lamp with massage stones may be employed to heat one or more massage stones. The one or more heated massage stones may then be placed on various strategic points on the person's body to further relax and sooth the patient. Various models of massage therapy lamps may be formed from salt stone, unique to this application for salt's superior ability to hold and transfer heat to the patient/consumer.

Heated massage salt lamps may be used by professional massage therapist, couples, families and even for personal consumer use.

Because the lamp requires a light and heat source, a 25 w incandescent light bulb. It is necessary that the bulb be placed in the middle of the lamp for correct light and heat distribution within the lamp. Because of this, the stone balls and consumers hands may easily come into contact with the bulb. 25 w incandescent bulbs can reach surface temperatures above 300 degrees F.

Massage stones that are to be heated by a massage therapy lamp may also damage the bulb if they are not delicately placed into the lamp. Accordingly, a mechanism for protecting the incandescent light bulb of a massage therapy lamp from breakage and potential burns by the consumer is desired. It is therefore desirable that such a mechanism/barrier should prevent the massage stones from directly contacting the incandescent light bulb.

### SUMMARY OF THE INVENTION

A salt stone massage therapy lamp is provided. The salt stone massage therapy lamp includes an incandescent light bulb as a light source and also a heating element for heating a of massage stones. The salt stone massage therapy lamp further includes a mechanism for protecting the incandescent light bulb and preventing the massage stones from coming into direct contact with the bulb thus protecting the bulb, as well as protecting the user's hands from the high temperatures of the incandescent bulb.

An embodiment of a salt stone massage therapy lamp includes a base having an electrical socket for receiving an incandescent light bulb. A bowl is mounted to the base. The bowl defines a concave storage space as well as an aperture near a bottom portion of the bowl. The aperture is located such that an incandescent light bulb installed in the electrical socket in the base at least partially protrudes into said concave storage space which is open to the air which is rightfully easily accessible by consumers. A plurality of removable massage stones are to be stored in the concave storage space.

Because of this exposed incandescent bulb, a mechanism has been developed to create a barrier within the container and are arranged to prevent the one or more massage stones, or consumers hands from contacting the incandescent light bulb, while allowing heat and light to freely pass through the barrier.

### BRIEF DESCRIPTION OF THE DRAWINGS

FIG. 1 is a three-dimensional representation of a Himalayan salt stone massage therapy lamp;

FIG. 2 is a cross sectional view of the base of a Himalayan salt stone massage therapy lamp of FIG. 1;

FIG. 3 is a cross sectional view of a translucent bowl for use in the Himalayan salt stone massage therapy lamp of FIG. 1;

FIG. 4 is a cross sectional view of a protective cage for use in the Himalayan salt stone massage therapy lamp of FIG. 1;

FIG. 5 is a cross sectional view of the fully assembled Himalayan salt stone massage therapy lamp of claim 1.

### DETAILED DESCRIPTION OF THE PREFERRED EMBODIMENTS

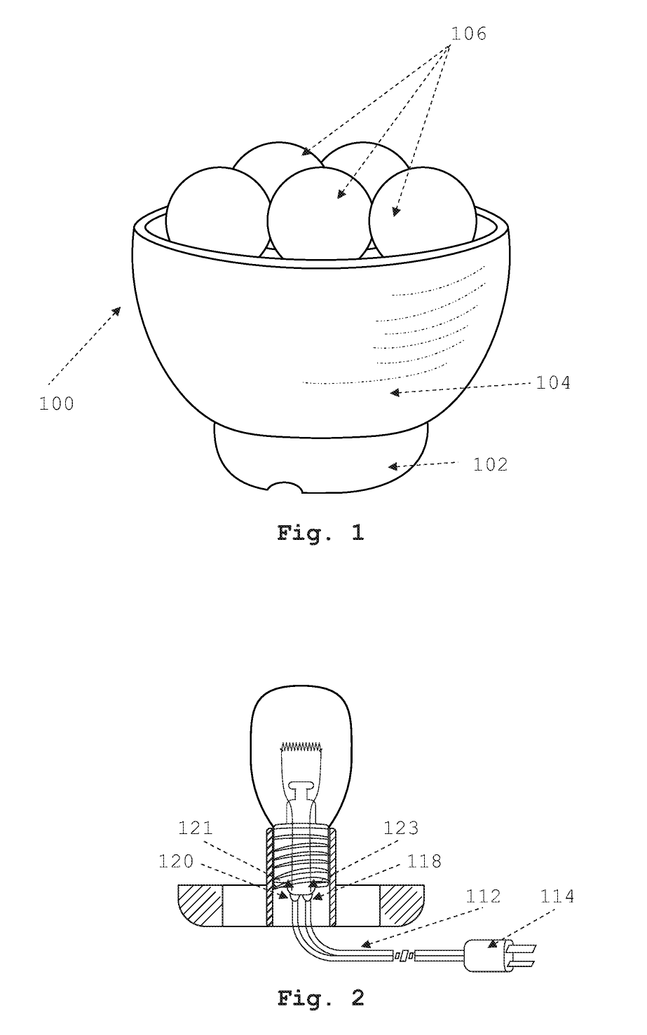

The present invention relates to a Himalayan salt stone massage therapy lamp. As shown in FIG. 1, a salt stone lamp 100 according to the present invention includes a base 102, a translucent storage bowl 104, and a plurality of substantially spherical massage stones 106 which are stored and warmed in the translucent storage bowl 104. As will be described in more detail with reference to FIG. 2, the base 102 includes an electrical light socket for receiving an incandescent light bulb. When the lamp 100 is connected to an electrical power source and the lamp is turned on, the incandescent light bulb both illuminates the translucent storage bowl 104 and heats the massage stones 106 stored therein. According to an embodiment of the invention, the translucent bowl 104 and the massage stones 106 are formed from Himalayan salt stone. Heating the salt stone bowl and the salt stone massage stones releases negative ions from the salt stone into the air to purify the atmosphere in the vicinity of the lamp 100.

FIG. 2 is a cross sectional view of the base 102 of the massage therapy lamp 100 of FIG. 1. The base 102 includes an electrical light socket 108. A power cord 112 is attached to electrical terminals 121, 123 of the light socket 108. The power cord 114 terminates in a standard plug 114 that may be inserted into a typical household electrical outlet to provide electrical power to the lamp 100. An incandescent light bulb 110 is installed in the electrical light socket 108 to illuminate the lamp and heat the salt stone bowl 104 and the massage stones 106 stored therein.

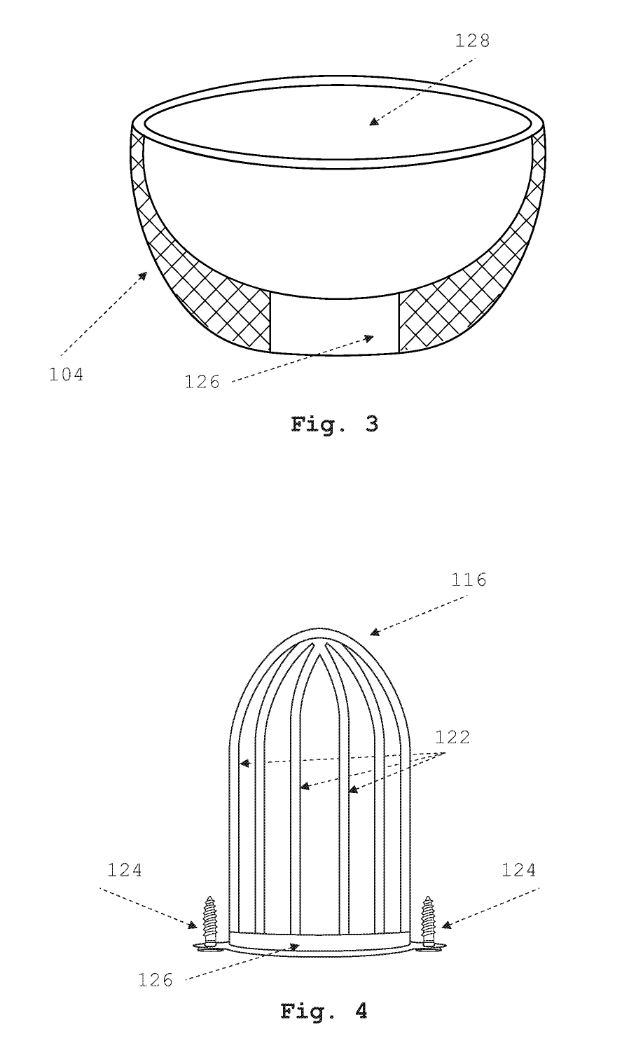

FIG. 3 is a cross sectional view of the translucent bowl 104 that mounts atop the base 102. The translucent bowl 104 defines an aperture 126 that allows the incandescent light bulb 110 installed in the electrical light socket 108 to protrude into an interior storage space 126 defined by the bowl 104 when the bowl is mounted on the base. 102.

FIG. 4 is a cross sectional view of a protective cage 116 adapted to be inserted into the aperture 126 formed in the bottom of the translucent bowl 104. The protective cage 116 is formed of a plurality of small diameter steel rods 122 extending upward from a circular base. Mounting screws 124 are provided to secure the protective cage 116 to the translucent bowl 104 once the protective cage has been installed within the aperture 126.

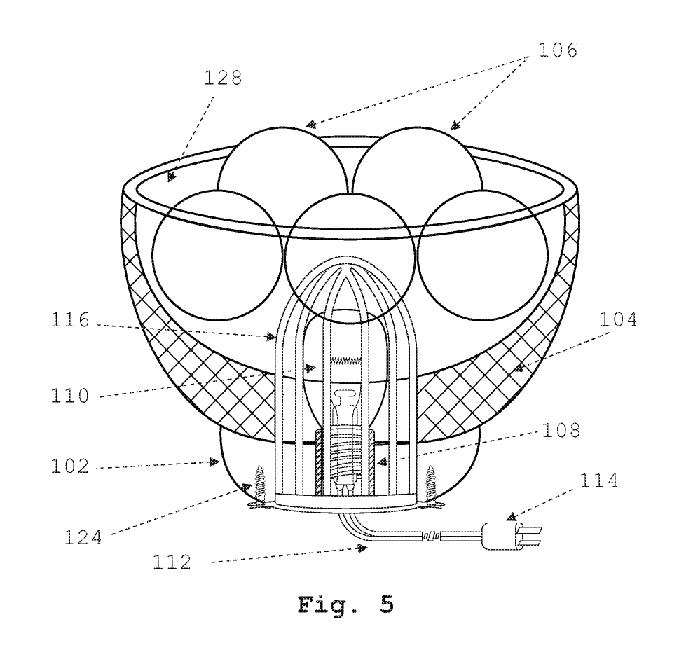

FIG. 5 is a cross sectional view of a fully assembled Himalayan salt stone massage therapy lamp 100 according the the present invention. The protective cage 116 is inserted into the aperture 126 formed in the bottom of the translucent bowl 104, and partially extends into the internal storage space 128 defined by the translucent bowl 104. The protective cage 116 is secured to the translucent bowl 104 via the mounting screws 124. An incandescent light bulb 110 is screwed into the light socket 108. The translucent bowl 104 with the protective cage 116 mounted thereto is placed over the base 102 and the electrical socket 108 so that the incandescent light bulb 110 extends through the aperture 126 and partially protrudes into the internal storage space 128 defined by the translucent bowl 104. The power cord 112 may be connected to a standard wall outlet (not shown) via the two pronged plug 114, to illuminate the lamp 100. Finally, a plurality of substantially spherical massage stones 106 are placed into the internal storage space 128 defined by the translucent bowl 104. Like the translucent bowl, the massage stone may be formed from Himalayan salt stone. As can be seen, the steel rods 122 of the protective cage 116 form obstacles that create a barrier preventing the massage stones 106 from contacting and perhaps damaging the incandescent light bulb 110.

When the lamp 100 is plugged in and switched on, the incandescent light bulb illuminates the translucent bowl and the plurality of massage stones 106. The incandescent light bulb 110 also acts to heat the translucent bowl and the massage stones 106. When heated the Himalayan salt comprising the translucent bowl and the massage stones releases negative ions into the air, purifying the atmosphere surrounding the salt stone massage therapy lamp 100. The heated massage stones 106 may be removed from the translucent bowl 104 and used for giving a relaxing and comforting massage.

Various embodiments of the invention have been described and illustrated; however, the description and illustrations are by way of example only. Other embodiments and implementations are possible within the scope of the invention and will be apparent to those of ordinary skill in the art. Therefore, the invention is not limited to the specific details of the representative embodiments and illustrated examples in this description. Accordingly, the invention is not to be restricted except as necessitated by the accompanying claims and their equivalents.

What is claimed is:

1. A massage therapy lamp comprising:
a base having an electrical socket for receiving an incandescent light bulb;
a bowl mounted to the base, the bowl defining a concave storage space and an aperture near a bottom portion of the bowl, the aperture located such that an incandescent light bulb installed in said electrical socket at least partially protrudes into said concave storage space;
a plurality of removable massage stones stored in the concave storage space; and
a protective barrier preventing the massage stones from directly contacting the incandescent light bulb.

2. The massage therapy lamp of claim 1 wherein the bowl and the plurality of massage stones are formed of a translucent material.

3. The massage therapy lamp of claim 2 wherein the bowl and the plurality of massage stones are formed of salt stone.

4. The massage therapy lamp of claim 1 wherein the massage stones are substantially spherical having a massage stone diameter and the protective barrier comprises a plurality of physical obstacles spaced a distance apart around the incandescent light bulb, the distance being less than the massage stone diameter.

5. The massage therapy lamp of claim 4 wherein the physical obstacles comprise steel rods.

6. The massage therapy lamp of claim 1 wherein the protective barrier comprises a protective cage having openings smaller that the massage therapy stones.

7. A lamp comprising:
a light socket;
an incandescent light bulb installed in said light socket;
a container at least partially surrounding said incandescent light bulb;
one or more massage stones adapted to be removably stored in said container;
one or more obstacles within the container arranged to prevent the one or more massage stones from contacting the incandescent light bulb.

8. The lamp of claim 7 wherein the container comprises a translucent bowl defining a concave storage space above the base.

9. The lamp of claim 8 wherein the translucent bowl and the massage stones are formed of salt stone.

10. The lamp of claim 7 wherein the one or more obstacles comprise a plurality of steel rods spaced a distance apart that is smaller than a width of the massage stones.

11. The lamp of claim 10 wherein the steel rods are formed into a cage surrounding the incandescent light bulb.

12. A Himalayan salt stone massage therapy lamp comprising:
a base supporting an electrical light socket;
an incandescent light bulb installed in said electrical light socket;
a translucent salt stone warming bowl mounted on said base, wherein the warming bowl defines a passage through a bottom surface of the warming bowl, allowing the incandescent light bulb to at least partially protrude into an interior storage space defined by the warming bowl;
a protective cage formed of a plurality of substantially rigid rods partially surrounding the incandescent light bulb; and
a plurality of salt stone spheres adapted to be stored within the interior storage space defined by the warming bowl, the protective cage preventing the plurality of salt stone spheres from contacting the incandescent light bulb.

13. The Himalayan salt stone massage therapy lamp of claim 12 wherein the rods comprising the protective cage define openings between the rods that are smaller than the salt stone spheres.
